(19) United States
(12) Patent Application Publication
(10) Pub. No.: US 2004/0168653 A1
(43) Pub. Date: Sep. 2, 2004

(54) Fuel tank design for engine-driven generator

(76) Inventor: David E. Radtke, New London, WI (US)

Correspondence Address: OSTRAGER CHONG & FLAHERTY LLP, 825 THIRD AVE, 30TH FLOOR, NEW YORK, NY, 10022-7519, US

(21) Appl. No.: 10/376,416

(22) Filed: Feb. 28, 2003

(51) Int. Cl. F02B 63/00

(52) U.S. Cl. 123/2

(57) ABSTRACT

A fuel tank assembly for supplying fuel to an engine that drives an electric generator. The fuel tank assembly is incorporated in a power generation system comprising an internal combustion engine; an electric generator driven by the engine; and a support frame for supporting the engine, the fuel tank assembly and the generator. The fuel tank is supported at an elevation above the engine and is not mounted to the engine. One embodiment of the fuel tank assembly comprises a rotomolded plastic fuel tank having a lattice of stiffening ribs projecting from its bottom, a heat shield disposed between the engine and the fuel tank and in contact with the stiffening ribs, and a plurality of fasteners that fasten the heat shield to the fuel tank. The heat shield/fuel tank assembly is mounted to the support frame. The stiffening ribs prevent warping of the fuel tank bottom and, by raising the tank bottom away from the heat shield, provide air-insulated pockets that insulate the fuel tank from the heat generated by the engine.

### BACKGROUND OF THE INVENTION

This invention generally relates to engine-driven power supplies. In particular, the invention relates to systems for supplying fuel to engines that drive power supplies, such as power supplies for welders.

Engine-driven welding power supplies are well known, and may be driven either by a DC generator or an AC generator (also called an alternator-rectifier). An AC generator generally includes, in addition to an alternator, a reactor followed by rectifiers to provide a DC output. Electrical power produced by the generator as the engine drives rotation of the rotor is converted by known electrical components into useable welding power available at terminals.

Typically the engine is an internal combustion engine that burns gasoline. The engine is started either electrically (using a battery) or manually (by pulling a pull-start cable). Initially the engine may run at an idle speed (e.g., 2,200 rpm), with the speed being increased to a running speed when a load is applied to the generator. To turn off the welding machine, the engine must be turned off. In the case of an electric-start engine, the engine can be turned off by returning a start or ignition switch to its OFF position. In the case of a pull-start engine, the engine can be turned off by pressing a kill switch.

A vital part of an engine-driven generator is the tank that holds the fuel for the engine. In early engine-driven welding machines, the fuel tank was located entirely within the base of the machine. A filler hole was provided in a top wall of the tank. A suitable removable cap could be screwed on to close the filler hole. Upon removing the cap, a fuel nozzle could be inserted into the filler hole for filling the tank with fuel.

Although such prior fuel tanks served their intended purpose, they possessed certain disadvantages. For example, the top wall of the tank, and thus the filler hole, was at a low height on the welding machine, often only several inches above the floor. Consequently, a person filling the fuel tank was required to bend over to insert the fuel nozzle into the filler hole. A related drawback was that there was very little warning given to the person that the tank was approaching a full condition. As soon as the tank was filled up to the top wall, which was difficult to observe, any additional fuel would spill out the filler hole. The spilled fuel would run down the sides of the fuel tank and into the welding machine base, where it was impractical to wipe up. Fill gauges were often incorporated into the fuel tanks, but they were not sufficiently sensitive to indicate a full tank condition quickly enough to prevent spillover. Also, the filler hole was on one side of the welding machine, so that side of the machine could not be mounted against a wall.

The Blue Star 3500 engine-driven welder/generator, commercially available from Miller Electric Mfg. Co., Appleton, Wis., has an engine with a metal fuel tank mounted on top. The muffler is also located above the engine, thus limiting the size of the fuel tank.

There is a continuing need for improvements in the design of engine-driven welders/generators. In particular, there is a need for improvements in the design of the fuel tank of an engine-driven welder/generator and its method of installation.

### BRIEF DESCRIPTION OF THE INVENTION

The invention is directed to an improved fuel tank assembly for supplying fuel to an engine that drives an electric generator.

One aspect of the invention is an apparatus comprising: an internal combustion engine; a fuel tank designed to hold fuel for the engine; an electric generator driven by the engine; and a support frame for supporting the engine, the fuel tank and the generator, wherein the fuel tank is supported at an elevation above the engine and is not mounted to the engine.

Another aspect of the invention is a fuel tank assembly comprising a molded plastic fuel tank comprising a bottom and a plurality of stiffening ribs projecting from the bottom, a heat shield in contact with the stiffening ribs, and a plurality of fasteners that fasten the heat shield to the fuel tank.

A further aspect of the invention is a power generation system comprising: an internal combustion engine; a fuel tank designed to hold fuel for the engine; an electric generator driven by the engine; and a support frame for supporting the engine, the fuel tank and the generator, wherein the support frame comprises means for supporting the engine and the generator; and first and second members that support the fuel tank at an elevation above the engine.

Yet another aspect of the invention is a molded plastic fuel tank having a length and a width greater than its height, comprising a top, a bottom and four sides, the top comprising a fill inlet, a spillover trough that surrounds the fill inlet and extends to a side edge of the fuel tank, and a drainage channel in flow communication with the spillover trough at the side edge, and the bottom comprising a plurality of stiffening ribs.

Other aspects of the invention are disclosed and claimed below.

### BRIEF DESCRIPTION OF THE DRAWINGS

FIG. 1 is a drawing showing an isometric view of an engine-driven welder/generator in accordance with one embodiment of the invention.

FIG. 2 is a drawing showing another isometric view of the engine-driven welder/generator of FIG. 1, but with the top cover and muffler cover removed.

FIG. 3 is a drawing showing an isometric view (from above) of the fuel tank incorporated in the engine-driven welder/generator depicted in FIG. 2.

FIG. 4 is a drawing showing another isometric view (from above) of the fuel tank of FIG. 3.

FIGS. 5 and 6 are drawings showing respective elevational views of opposite ends of the fuel tank of FIG. 3.

FIG. 7 is a drawing showing yet another isometric view (from above) of the fuel tank of FIG. 3.

FIG. 8 is a drawing showing a further isometric view (from below) of the fuel tank of FIG. 3.

FIG. 9 is a drawing showing a top view of a heat shield to which the fuel tank of FIG. 3 is mounted. The heat shield is shown prior to being bent into its final configuration.

FIG. 10 is a drawing showing a top view of the heat shield of FIG. 9 after bending.

FIG. 11 is a drawing showing an elevational view of one side of the heat shield shown in FIG. 10.

FIG. 12 is a drawing showing an elevational view of one end of the heat shield shown in FIG. 10.

Reference will now be made to the drawings in which similar elements in different drawings bear the same reference numerals.

### DETAILED DESCRIPTION OF THE INVENTION

While the present invention will be illustrated with reference to a particular engine-driven welder/generator, it should be understood at the outset that the invention in its broadest scope may be applied to engine-driven generators not used in conjunction with or incorporated in a welding machine.

One type of known AC generator-driven power supply comprises an engine, a generator having a rotor driven by the engine and having various stator windings for providing welding and auxiliary outputs induced by the driven rotor. An electronic field current controller board regulates the welding and auxiliary outputs of the generator. In a welder/generator, the stator comprises various windings (not shown), including a welding power output winding, an exciter winding and auxiliary power output windings. The welding power output winding provides current to one electrode typically located at the tip of a welding gun, while a ground clamp is attached to the workpiece. The welding power output winding produces a desired voltage potential difference across the welding electrodes.

The generator may be either a three-phase or a single-phase generator. In response to current from the field current controller board, the rotor winding creates electromagnetic fields that induce current in the various stator windings. The main output of the power supply may be used for welding or for other purposes, such as plasma cutting or other high power loads. Generally, the auxiliary output windings are used to provide an auxiliary power output (current, voltage and/or power). The auxiliary output is often used to power tools, lights, etc., that require 110 VAC. Thus, the auxiliary output is typically 110 VAC, but may be 240 or 480 VAC.

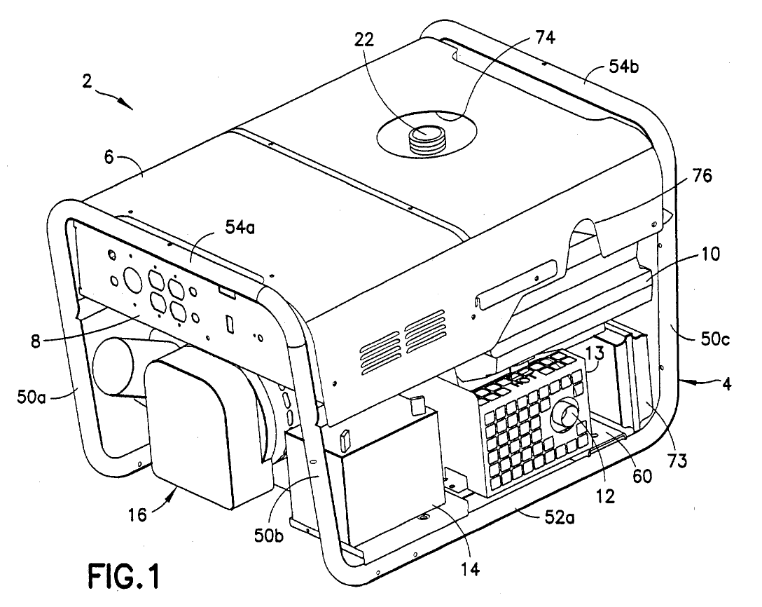

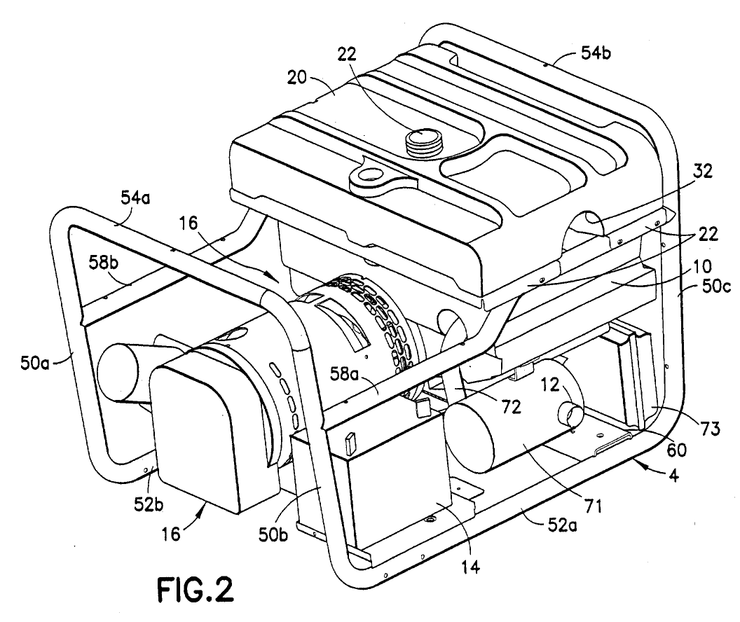

An engine-driven welder/generator 2 (without welding attachments) in accordance with one embodiment of the invention is shown in FIGS. 1 and 2. The unit comprises a support frame 4 in the form of a tubular roll cage, a top cover 6, a welding control box 8, an engine 10, a muffler outlet 12, a battery 14, an electric generator 16 and an air cleaner 73 that filters ambient air entering the engine. The apparatus further comprises a fuel tank 20 for supplying fuel to the engine. The engine 10, generator 16 and battery 14 are all mounted to the base of the support frame 4, while the cover 6, control box 8 and fuel tank are mounted to a pair of support members 58a and 58b, seen in FIG. 2.

Referring to FIG. 2, the support frame 4 comprises four generally vertical straight tubular members (only three, designated 50a, 50b and 50c, are visible in FIG. 2) located at respective corners of the frame. The bottoms of respective pairs of the vertical tubular members are connected by a pair of tubular base members 52a and 52b, while the tops of respective pairs of the vertical tubular members are connected by a pair of tubular cross members 54a and 54b. As seen in FIG. 2, the support frame further comprises a first tubular support member 58a that spans the vertical members 50b and 50c, and a second tubular support member 58b that spans the vertical member 50a and the fourth vertical member not visible in FIG. 2. The support member 58a overlies the base member 52a, while the support member 58b overlies the base member 52b. The support members each comprise a pair of mutually parallel straight sections offset from each other and connected by an oblique section that increases the bending strength of the support members. The support members 58a and 58b support a fuel tank assembly comprising a plastic fuel tank 20 mounted to a metal heat shield 21, as will be explained in more detail below. The support members 58a and 58b also support the welding control box (not shown in FIG. 2).

The support frame 4 further comprises a pair of support brackets 60, only one of which is visible in FIGS. 1 and 2. The ends of the support brackets 60 are respectively welded to the base members 52a and 52b. The engine/generator assembly is supported by the support brackets 60. The battery 14 is also supported by one of the support brackets, except via the intermediary of a battery mounting tray mounted to the support bracket directly below, but not visible in FIGS. 1 and 2.

Referring to FIG. 2, the welder/generator further comprises a muffler that reduces the amplitude of the acoustic noise emitted by the engine. The muffler has an outlet 12 that does not project beyond the plane defined by the tubular members 50b, 50c, 52a and 58a. FIG. 1 shows the muffler outlet 12 protruding through a muffler cover 13 that is attached to a flange on the battery mounting plate by a bracket, while FIG. 2 shows the muffler with the muffler cover removed.

As seen in FIG. 2, the muffler comprises a canister 71 and a curved pipe 72. The pipe 72 couples an exhaust port of the engine 10 to an inlet (not shown) of the canister 71. Typically, the canister 71 and pipe 72 are welded together. The inlet end of the pipe 72 is attached to the exhaust port of the engine 10, while the muffler canister 71 is mounted to the engine via a bracket welded to the top of the muffler canister and bolted to the engine. The engine exhaust port (i.e., the muffler inlet) is located at an elevation higher than the elevation of the muffler outlet 12.

As seen in FIG. 2, the fuel tank 20 is disposed above the engine 10. The output shaft (not shown) of the engine 10 and the rotor (not shown) of the generator 16 are coaxial. The welding control box occupies the space above the generator 16 in FIG. 2. The canister 71 is disposed in a space located under and beside respective portions of the engine 10, that space in turn being located between the battery 14 and the air cleaner 73. The battery 14 is disposed beside the generator 16.

The fuel tank assembly will now be described with reference to FIGS. 1 and 2. As seen in FIG. 2, the fuel tank 20 is mounted to a generally horizontal heat shield 21, which is in turn attached to and spans the support members 58a and 58b of the support frame. The fuel tank 20 is filled via a threaded fill neck 22. A gas cap (not shown) will be threadably coupled to the fill neck 22 to close the fuel tank. As seen in FIG. 1, the top cover 6 has a circular cutout 74 to allow access to the fill neck 22, as well as a cutout 76 on the side of the cover to provide access to the spark plug (not shown) of the engine. The cutout 76 (see FIG. 1) in the cover 6 aligns with the relief 32 (see FIG. 2) in the fuel tank.

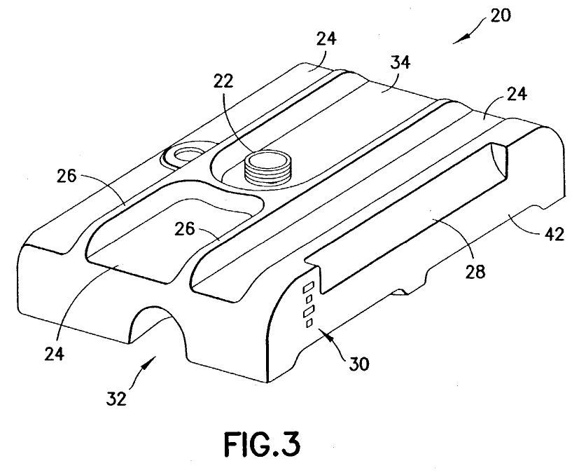

The structure of the fuel tank is shown in detail in FIGS. 3-8. The fuel tank 20 is a generally box-shaped plastic structure made by a rotomolding process, whereby the thickness of the tank walls is relatively constant throughout the structure. The fuel tank 20 has a length and a width that are substantially greater than its height. The tank comprises a top and a bottom connected on four sides. The top has a fill neck 22 with external threads for screwing on the gas cap.

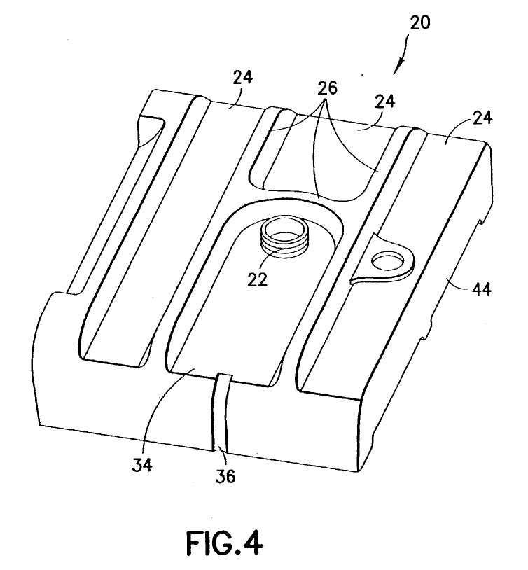

Referring to FIGS. 3, 4 and 7, the top comprises walls 24 and 34 that are domed toward the central fill point to allow air to escape. The top further comprises a lattice of stiffening ribs 26. The top wall area 34, which surrounds the fill neck 22, is bordered on two sides and along a semicircular arc by stiffening ribs 26, thus forming a fuel spillover trough. Since the wall is domed toward the fill inlet, any fuel that spills into the spillover trough will flow toward the edge of the fuel tank under the influence of gravity. At the end of the spillover trough, the fuel tank is in contact with the top cover. A drainage channel 36 (see FIGS. 4 and 7) formed on one side of the fuel tank provides an escape route for fuel spilled onto the spillover trough, thereby preventing fuel from pooling on top of the fuel tank. The drainage channel 36 is formed on the side of the fuel tank that faces away from the side of the welder/generator on which the muffler is disposed, thus allowing excess fuel to run down the side of the tank under the machine's cover and away from ignition sources.

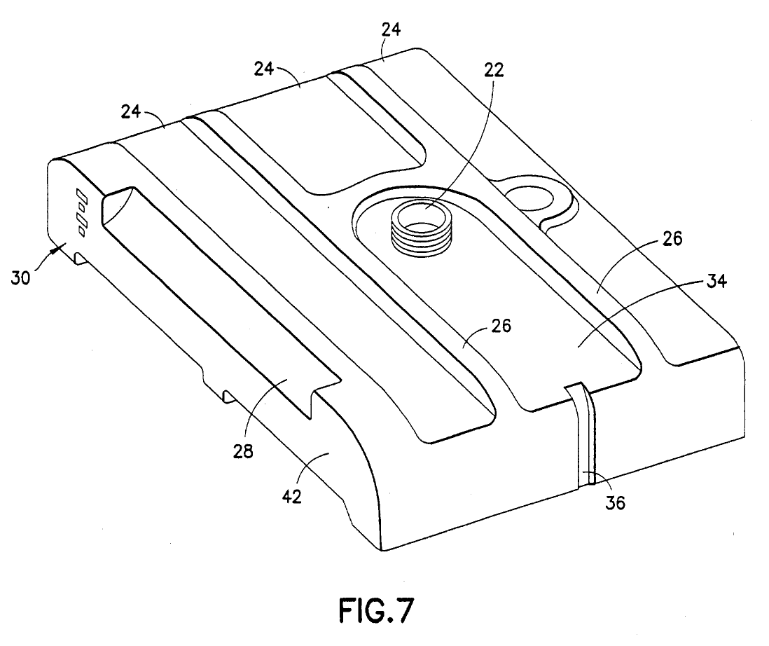

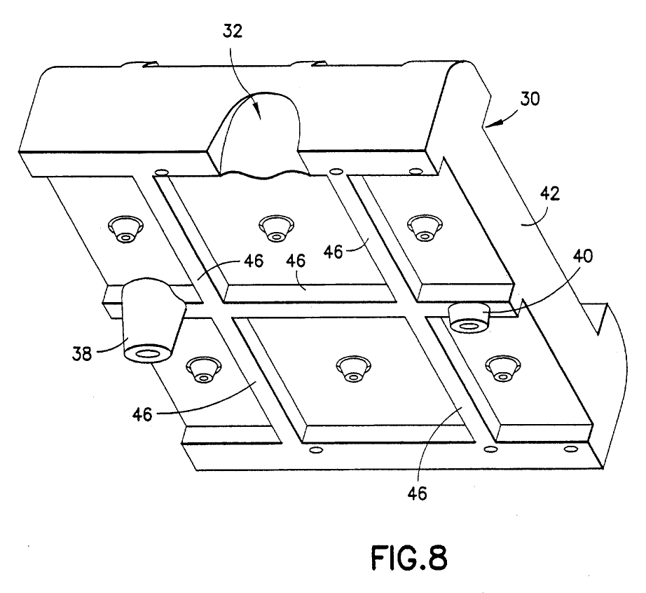

Referring to FIG. 8, the bottom comprises a lattice of stiffening ribs 46 that prevent the tank bottom from warping; a first cup-shaped molded structure 38 that forms a clearance trough inside the fuel tank for placement of a float gauge; and a second cup-shaped molded structure 40, having an opening at the bottom, that forms a clearance trough for placement of a fuel shutoff valve. The opening in trough 40 receives the fuel line to the engine.

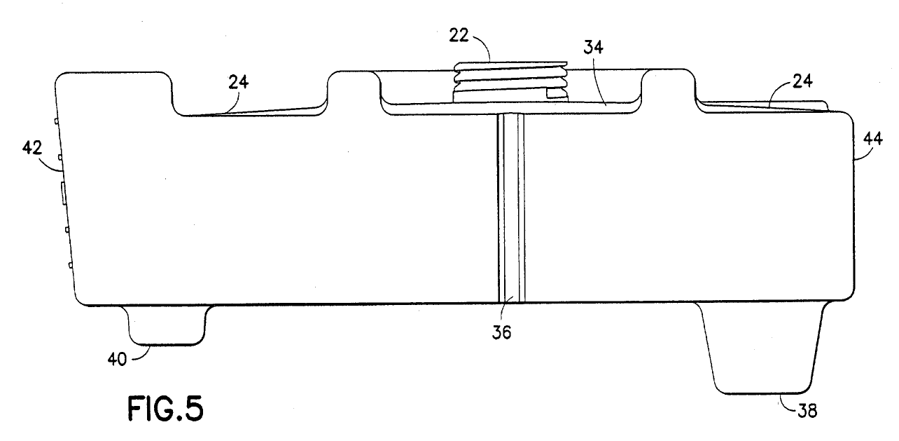

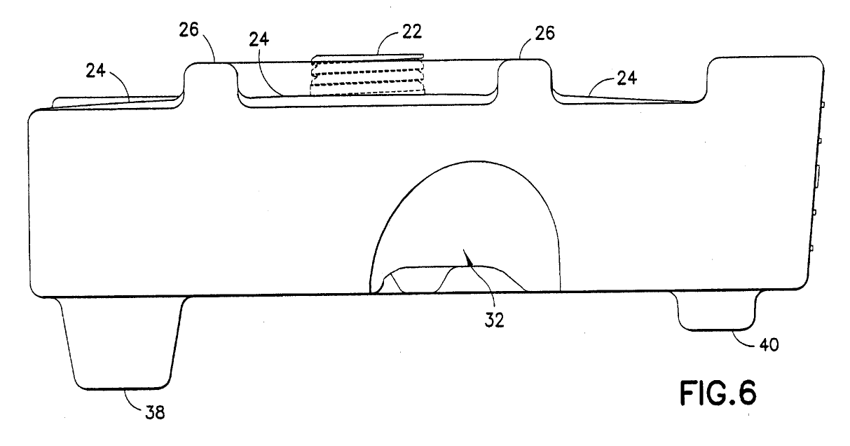

Side wall 42 (see FIG. 3) comprises spaced bar-shaped regions that are semi-transparent, these bars forming a “sight” fuel gauge allowing someone to see the fuel level inside the tank through the semi-transparent regions. A relief 28 (see FIGS. 3 and 7) is provided along the edge where the side wall 42 meets the top of the tank, which relief faces the tubular cross member 54b shown in FIG. 2 and provides room for a person to grab cross member 54b, for example, when manually moving the welder/generator. The side wall 42 is opposed by an opposite side wall 44 (see FIG. 4). The other side walls, running generally perpendicular to side walls 42 and 44, are respectively shown in FIGS. 5 and 6.

FIG. 5 shows the drainage channel 36 in flow communication with the spillover trough 34. The edge of the tank can be raised at the end of the spillover trough so that the only avenue for fuel discharge is into the discharge channel.

FIG. 6 shows the side of the fuel tank that is on the same side of the welder/generator as the muffler. As best seen in FIGS. 3 and 8, a relief 32 is molded into this side of the tank to provide access to the engine spark plug. As previously mentioned, the top cover 6 (see FIG. 1) has a cutout 76 that is aligned with the relief 32 at the side of the fuel tank.

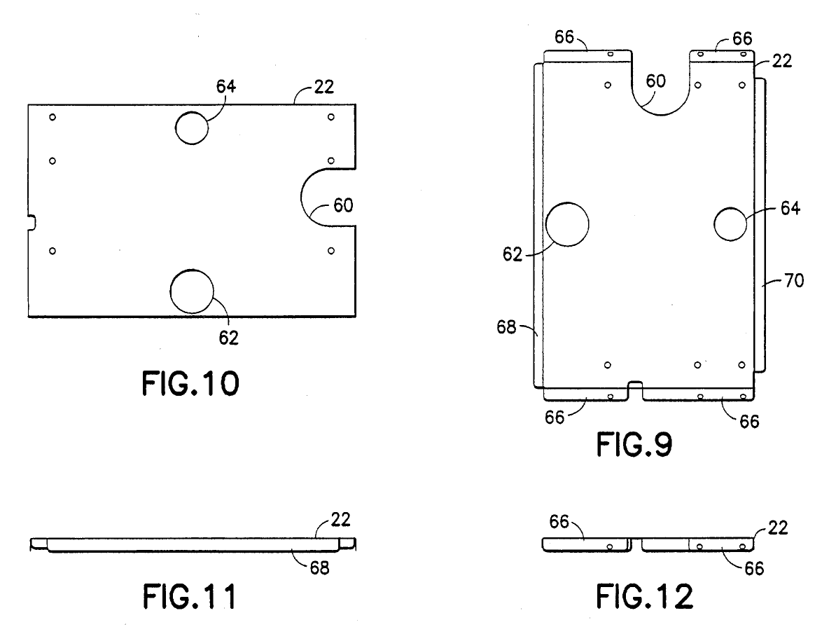

The heat shield 21, shown in FIGS. 9-12, also has a cutout 60 that aligns with the relief, but at the bottom of the fuel tank, again to allow spark plug access. During welder/generator assembly, first the fuel tank is fastened to the heat shield, and then the fuel tank/heat shield assembly is fastened to the support frame. This is accomplished as follows.

As previously described, the fuel tank is rotomolded from plastic material. In one embodiment of the present invention, a plurality of tapped inserts made of aluminum alloy (not shown in the drawings) are insert-molded into the bottom of the plastic fuel tank. These inserts are arranged to align with clearance holes in the heat shield when the bottom of the fuel tank is placed on the heat shield.

The heat shield comprises a generally rectangular sheet of metal (e.g., steel) that is cut as shown in FIG. 9. The cuts include the cutout 60 for spark plug access as well as a pair of circular clearance holes 62 and 64 for passage of the cup-shaped structures (38 and 40 in FIG. 8) projecting from the bottom of the fuel tank. A small cutout, which will later align with the drainage channel on the fuel tank, is made on the side of the sheet opposite to the cutout 60. In addition, the corners of the metal sheet are cut out as shown in FIG. 9. It should be noted that the margin 70 has longer cuts to provide clearance for the support members 58a and 58b (see FIG. 2) on that side of the heat shield. The margins 66, 68 and 70 of the heat shield are then folded in the same direction to positions substantially perpendicular to the plane of the sheet. Three views of the folded sheet are presented in FIGS. 10-12. The folded margins 66 at both ends of the heat shield serve to capture the support members 58a and 58b, on which the heat shield will be seated, as explained below.

After the fuel tank and the heat shield have been separately fabricated, the heat shield is mated with the bottom of the fuel tank, with cutout 60 in the heat shield aligned with relief 32 in the fuel tank, and with the molded structures 38 and 40 respectively passed through the clearance holes 62 and 64 in the heat shield. Then the heat shield and fuel tank are fastened together using screws. Each screw passes through a respective clearance hole in the heat shield and threadably engages a respective tapped insert in the molded fuel tank. Optionally, the inserts are not tapped and self-threading screws are used.

The resulting heat shield/fuel tank assembly is then mounted to the support frame 4 as shown in FIG. 2, with the heat shield 21 disposed between the engine 10 and the fuel tank 20. Opposing sections of the tubular support members 58a and 58b are captured between the folded margins 66 (see FIG. 9) of heat shield 21. Those same folded margins are fastened to the support members using self-threading screws. The relief 32 in the fuel tank provides access to the engine spark in the space behind the opposing section of the tubular support member 58a. The top cover 6 is then fastened to the support members 58a, 58b (see FIG. 1), also using self-threading screws.

The invention provides numerous advantages. The fuel tank disclosed herein has a storage capacity greater than that of the fuel tank typically provided by the engine manufacturer. This allows the welder/generator disclosed herein to run for a longer period of time without refueling. In addition, the stiffening ribs on the bottom of the fuel tank prevent warping of the fuel tank bottom and, by raising the tank bottom away from the heat shield, provide air-insulated pockets that insulate the fuel tank from the heat generated by the engine. A further advantageous aspect is that the molded fuel tank is molded with a relieved area to provide access to the spark plug of the engine in the final assembly. Also the fuel tank is molded to have a spillover trough on the top and a discharge channel on the side that allows excess fuel to run down the side of the tank under the machine's cover and away from ignition sources.

In accordance with an alternative embodiment of the invention, the heat shield can be eliminated. In this case, the fuel tank is not fastened to the support frame and instead is trapped between the support members 58a and 58b (see FIG. 2) and the top cover 6 (see FIG. 1).

While the invention has been described with reference to preferred embodiments, it will be understood by those skilled in the art that various changes may be made and equivalents may be substituted for members thereof without departing from the scope of the invention In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. An apparatus comprising: an internal combustion engine; a fuel tank designed to hold fuel for said engine; an electric generator driven by said engine; and a support frame for supporting said engine, said fuel tank and said generator, wherein said fuel tank is supported at an elevation above said engine and is not mounted to said engine.

2. The apparatus as recited in claim 1, wherein said support frame comprises a tubular roll cage.

3. The apparatus as recited in claim 1, further comprising a heat shield disposed between said engine and said fuel tank, said heat shield being fastened to said support frame.

4. The apparatus as recited in claim 3, wherein said support frame comprises first and second members, and said heat shield comprises a sheet of metal having first and second bent margins that capture said first and second members of said support frame.

5. The apparatus as recited in claim 3, wherein said fuel tank is fastened to said heat shield.

6. The apparatus as recited in claim 5, wherein said fuel tank is made of molded plastic, further comprising a plurality of metal inserts insert-molded into said plastic fuel tank, and a plurality of fasteners respectively coupled to said plurality of metal inserts for fastening said fuel tank to said heat shield.

7. The apparatus as recited in claim 5, wherein said fuel tank has a relief and said heat shield has a cutout aligned with said relief for allowing access to a spark plug of said engine.

8. The apparatus as recited in claim 7, further comprising a top cover fastened to said support frame and comprising a side wall portion having a cutout aligned with said relief in said fuel tank.

9. The apparatus as recited in claim 5, wherein said fuel tank is made of molded plastic and comprises a bottom and a plurality of stiffening ribs projecting downward from said bottom, thereby providing an air-insulated pocket between said fuel tank and said heat shield.

10. The apparatus as recited in claim 9, wherein said fuel tank further comprises a molded cup-shaped structure that projects downward from said bottom, forming a cup-shaped trough inside said fuel tank, and said heat shield comprises an aperture that provides clearance for said cup-shaped structure to pass through.

11. The apparatus as recited in claim 1, wherein said fuel tank is made of molded plastic and comprises a fill inlet, a spillover trough that surrounds said fill inlet and extends to a side edge of said fuel tank, and a drainage channel in flow communication with said spillover trough at said side edge.

12. The apparatus as recited in claim 1, wherein said support frame comprises first and second members, and said fuel tank sits on said first and second members without being fastened thereto.

13. The apparatus as recited in claim 12, further comprising a top cover fastened to said support frame and shaped to trap said fuel tank in place on said first and second members without being fastened thereto.

14. A fuel tank assembly comprising a molded plastic fuel tank comprising a bottom and a plurality of stiffening ribs projecting from said bottom, a heat shield in contact with said stiffening ribs, and a plurality of fasteners that fasten said heat shield to said fuel tank.

15. The fuel tank assembly as recited in claim 14, further comprising a plurality of metal inserts insert-molded into said plastic fuel tank, wherein said plurality of fasteners are respectively coupled to said plurality of metal inserts.

16. The fuel tank assembly as recited in claim 14, wherein said fuel tank has a relief and said heat shield has a cutout aligned with said relief.

17. The fuel tank assembly as recited in claim 14, wherein said fuel tank further comprises a molded cup-shaped structure that projects downward from said bottom, forming a cup-shaped trough inside said fuel tank, and said heat shield comprises an aperture that provides clearance for said cup-shaped structure to pass through.

18. The fuel tank assembly as recited in claim 14, wherein said fuel tank comprising a fill inlet, a spillover trough that surrounds said fill inlet, and a drainage channel in flow communication with said spillover trough, said spillover trough being formed in a top of said fuel tank and said drainage channel being formed in a side of said fuel tank.

19. A power generation system comprising: an internal combustion engine; a fuel tank designed to hold fuel for said engine; an electric generator driven by said engine; and a support frame for supporting said engine, said fuel tank and said generator, wherein said support frame comprises means for supporting said engine and said generator; and first and second members that support said fuel tank at an elevation above said engine.

20. The system as recited in claim 19, further comprising a heat shield that spans and is coupled to said first and second support members, said fuel tank being mounted to said heat shield.

21. The system as recited in claim 20, wherein said fuel tank is made of molded plastic and comprises a bottom and a plurality of stiffening ribs projecting downward from said bottom, thereby providing an air-insulated pocket between said fuel tank and said heat shield.

22. The system as recited in claim 20, wherein said fuel tank is made of molded plastic, further comprising a plurality of metal inserts insert-molded into said plastic fuel tank, and a plurality of fasteners respectively coupled to said plurality of metal inserts for fastening said fuel tank to said heat shield.

23. The system as recited in claim 20, wherein said fuel tank has a relief and said heat shield has a cutout aligned with said relief for allowing access to a spark plug of said engine.

24. The system as recited in claim 23, further comprising a top cover fastened to said support frame and comprising a side wall portion having a cutout aligned with said relief in said fuel tank.

25. The system as recited in claim 21, wherein said fuel tank further comprises a molded cup-shaped structure that projects downward from said bottom, forming a cup-shaped trough inside said fuel tank, and said heat shield comprises an aperture that provides clearance for said cup-shaped structure to pass through.

26. The system as recited in claim 19, wherein said fuel tank is made of molded plastic and comprises a fill inlet, a spillover trough that surrounds said fill inlet and extends to a side edge of said fuel tank, and a drainage channel in flow communication with said spillover trough at said side edge.

27. A molded plastic fuel tank having a length and a width greater than its height, comprising a top, a bottom and four sides, said top comprising a fill inlet, a spillover trough that surrounds said fill inlet and extends to a side edge of said fuel tank, and a drainage channel in flow communication with said spillover trough at said side edge, and said bottom comprising a plurality of stiffening ribs.

28. The fuel tank as recited in claim 27, wherein said bottom further comprises a cup-shaped molded structure that projects downward.
